(19) United States
(12) Patent Application Publication
(10) Pub. No.: US 2013/0171605 A1
(43) Pub. Date: Jul. 4, 2013

(54) METHOD AND SYSTEM FOR DETERMINING ANSWERER

(71) Applicant: China Mobile Communications Corporation, Beijing (CN)

(72) Inventor: Renjie TANG, SAN JOSE, CA (US)

(73) Assignee: CHINA MOBILE COMMUNICATIONS CORPORATION, Beijing (CN)

(21) Appl. No.: 13/730,269

(22) Filed: Dec. 28, 2012

Related U.S. Application Data
(60) Provisional application No. 61/581,893, filed on Dec. 30, 2011.

(51) Int. Cl. G09B 5/00

(52) U.S. Cl. CPC G09B 5/00
USPC 434/352

(57) ABSTRACT

A method and system for determining an answerer is disclosed. The method includes: receiving a question from an asker; obtaining history answering statistics information of each online answerer, where an online answerer is a user with a label which represents that the user is available to answer a question; and determining from all online answerers at least one answerer for the question according to the history answering statistics information of each online answerer. With the method and system, an answerer which is available and suitable to answer a question can be determined for the question, and thus the question can be more likely to be answered quickly and correctly.

### CROSS REFERENCE TO RELATED APPLICATIONS

This application claims benefit and priority to U.S. Application No. 61/581,893, filed on Dec. 30, 2011, the entirety of which is incorporated herein by reference.

### FIELD

The present invention relates to the field of communications, and particularly to a method and system for determining an answer.

### BACKGROUND

With the advent of crowd sourcing, it is now possible to get your questions answered through an unknown person who knows the answer. Recently there are more developments in this space to make the question & answering easier. Twitter provides a platform for people to share whatever they want including asking questions. One might post a question on twitter hoping some people may see his question and answer his question. Social Q&A website provides a specific platform for its registered users to post questions and/or get questions answered.

U.S. patent application Ser. No. 12/207,199 discloses a method to extract question-answer pairs from online forums. In online forum postings, many of them are questions or answers to other people's questions. The method first discovers questions from the postings, and then discovers their corresponding answers.

U.S. patent application Ser. No. 10/553,479 provides a question-answering service. A first user can post a question, and the system will post the question on a webpage. A second user can evaluate the question and provide an evaluation (e.g., an answer). The system will calculate the evaluation and post on the webpage.

U.S. patent application Ser. No. 12/358,517 identifies a first set of question-answer pairs. When a second question query and candidate answers arrive, it identifies similar questions in the first set, and then identifies the linking feature between the identified questions and their answers. It uses the linking feature to rank the candidate answers.

U.S. Pat. No. 7,966,316 first identifies the type of a question posted by a user, and then generates an answer summary that summarizes answers to the question in a format that depends on the type of the question asked.

However, in all existing work it is still difficult to get an answer, let alone to enforce the quality of the answer. For example, there is a huge amount of postings each day on twitter. When one posts a question, it is easily lost in the river of tweets. As a result, many questions posted on twitter never get answered. While the specific social Q&A websites, such as Quora, allow people to ask questions and get answers, it is hard to guarantee that your question can be answered in a timely manner, especially if your question is time/location sensitive. Furthermore, in either case it is hard to know if the answers are correct or trustworthy. Nobody enforces the correctness or accuracy of the postings on Twitter. On social Q&A platforms such as Quora, many people answering people's question only aim to do advertising for their business, they may not be qualified to answer some particular questions at all.

There exist many questions that are very context dependent. Answers need to be different depending on the contexts. Contexts are dynamically changing including location and time.

For example, you may want to know about the traffic situation on a route that you are going to take now, or you want to know how long you have to wait in the line in an airport/train station/museum you want to visit at this moment. Such real time questions not only require correct answers but also very importantly demand answers in a timely manner. You can post such a question on twitter, but oftentimes you may not get an answer because your posting is quickly lost in the tweet streams. Even when you do get an answer, it may be already passed the deadline. Furthermore it is hard to know if that answer is trustworthy. For example the answer might come from someone who is not at the location your question is about. Overall, in existing solutions, there is no approach to facilitate your questions to be answered fast and to be answered correctly.

### SUMMARY

Embodiments of the invention provide a method and system for determining an answerer, so that an answerer which is available and suitable to answer a question can be determined, thus the question is more likely to be answered quickly and correctly.

An embodiment of the invention provides a method for determining an answerer, which includes:

receiving a question from an asker;

obtaining history answering statistics information of each online answerer, where an online answerer is a user with a label which represents that the user is available to answer a question; and

determining from all online answerers at least one answerer for the question according to the history answering statistics information of each online answerer.

An embodiment of the invention provides a system for determining an answerer, which includes:

a question receiving device configured to receive a question from an asker;

a statistics information obtaining device configured to obtain history answering statistics information of each online answerer, where an online answerer is a user with a label which represents that the user is available to answer a question; and

a determining device configured to determine from all online answerers at least one answerer for the question according to the history answering statistics information of each online answerer.

In schemes for determining an answerer according to the embodiments of the invention, a question from an asker is received, history answering statistics information of each online answerer is obtained, and at least one answerer for the question is determined from all online answerers according to the history answering statistics information of each online answerer, where an online answerer is a user with a label which represents that the user is available to answer a question. With the schemes, an answerer which is available and suitable to answer a question can be determined for the question, and thus the question can be more likely to be answered quickly and correctly.

### BRIEF DESCRIPTION OF THE DRAWINGS

FIG. 1 is a flow chart of a method for determining an answerer according to a first embodiment of the invention;

FIG. 2 is a flow chart of a method for determining an answerer according to a second embodiment of the invention;

FIG. 3 is a flow chart of a method for determining an answerer according to a third embodiment of the invention;

FIG. 4 is a flow chart of a method for determining an answerer according to a fourth embodiment of the invention;

FIG. 5 is a flow chart of a method for determining an answerer according to a fifth embodiment of the invention;

FIG. 6 is a flow chart for determining an answerer according to history answering statistics information of each online answerer in an embodiment of the invention;

FIG. 7 is a flow chart of a particular implementation of a method for determining an answerer according to an embodiment of the invention;

FIG. 8 is a schematic structural diagram of a system for determining an answerer according to an embodiment of the invention; and

FIG. 9 is a schematic structural diagram of a determining device according to an embodiment of the invention.

### DETAILED DESCRIPTION OF THE EMBODIMENTS

Embodiments of the invention provide a method for determining an answerer in which a question from an asker is received, history answering statistics information of each online answerer is obtained, and at least one answerer for the question is determined from all online answerers according to the history answering statistics information of each online answerer, where an online answerer is a user with a label which represents that the user is available to answer a question. Embodiments of the invention further provide a system for determining an answerer.

The embodiments of the invention will be described below in detail with reference to the drawings.

### First Embodiment

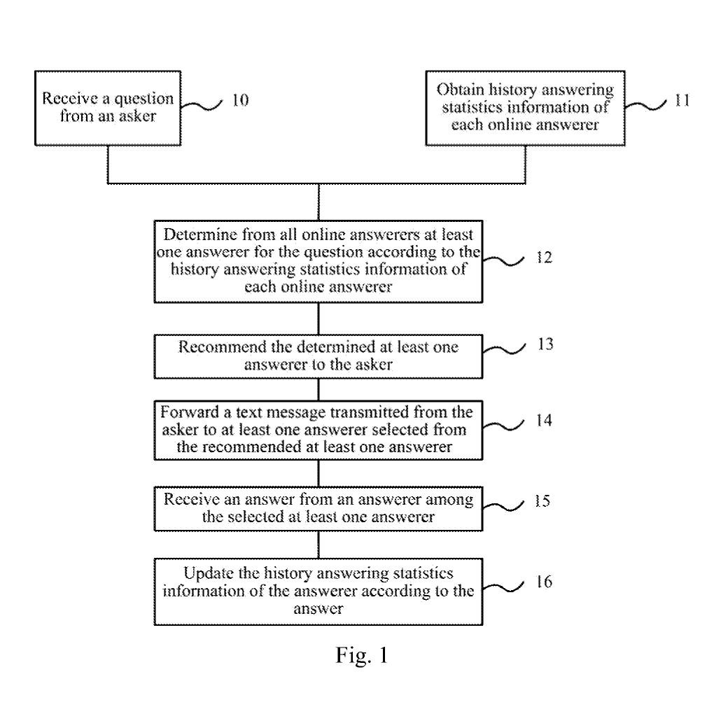

As illustrated in FIG. 1, a method for determining an answerer according to the first embodiment includes the following operations 10 to 16.

The operation 10 is to receive a question from an asker.

The operation 11 is to obtain history answering statistics information of each online answerer.

Where an online answerer is a user with a label which represents that the user is available to answer a question.

Particularly, a user who is available to answer a question may turn on his/her “I can help” feature. Thus those users turning on the “I can help” feature are online answerers.

Particularly, the history answering statistics information of each online answerer includes at least one of: an average speed of the answerer for answering questions in history; the number of types of questions answered by the answerer in history; an average speed of the answerer for answering each type of questions in history; the number of questions answered by the answerer in history; the number of each type of questions answered by the answerer in history; a correctness rate of the answerer for answering questions in history; a correctness rate of the answerer for answering each type of questions in history; the types of questions answered correctly by the answerer in history, etc.

Although contents of history answering statistics information is listed above, those skilled in the art can appreciate that the contents is not limited to those listed above.

The history answering statistics information of an answerer may be stored in a memory. When a question from an asker is received, all online answerers may be determined (all users currenctly turning on the “I can help” feature are determined) and the history answering statistics information of the all online answerers may be obtained from the memory.

The operation 12 is to determine from all online answerers at least one answerer for the question according to the history answering statistics information of each online answerer.

Particularly, in a specific embodiment, when the history answering statistics information of each online answerer includes an average speed of the answerer for answering questions in history, the online answerers may be ranked in a descending order of the average speeds of the answerers, and the first N answerers in the rank may be determined as the at least one answerer for the question, where N is a natural number and may be set by the asker. For example, when posting a question, an asker may also specify how many answerers he/she wants. In this specific embodiment, merely answering speed is considered in determining an answerer for a question, thus the question may be more likely to be answered quickly. If an asker prefers his/her question to be answered as quickly as possible, then this specific embodiment is applicable.

Alternatively, in another specific embodiment when the history answering statistics information of each online answerer includes the number of types of questions answered by the answerer in history, the online answerers may be ranked in a descending order of the number of types of questions answered by the answerers, and the first N answerers in the rank may be determined as the at least one answerer for the question, where N is a natural number. In this specific embodiment, merely diversity of questions answered in history is considered in determining an answerer for a question. If an asker believes that his/her question need to be answered by a learned person, then this specific embodiment is applicable, and thus the question may be more likely to be answered correctly.

Alternatively, in another specific embodiment when the history answering statistics information of each online answerer includes a correctness rate of the answerer for answering questions in history, the online answerers may be ranked in a descending order of the correctness rates of the answerers, and the first N answerers in the rank may be determined as the at least one answerer for the question, where N is a natural number. In this specific embodiment, merely a correctness rate is considered in determining an answerer for a question, thus the question is more likely to be answered correctly. If an asker seeks for a correct answer regardless of an answering speed, then this specific embodiment is applicable.

Alternatively, in yet another specific embodiment when the history answering statistics information of each online answerer includes an average speed of the answerer for answering questions in history and a correctness rate of the answerer for answering questions in history, the online answerers may be ranked based on the average speeds and correctness rates of the answerers, and the first N answerers in the rank may be determined as the at least one answerer for the question, where N is a natural number. In this specific embodiment, both an answering speed and a correctness rate are considered in determining an answerer for a question, thus the question is more likely to be answered quickly and correctly.

Ranking online answerers based on the average speeds and correctness rates of the answerers may be implemented in various ways, and the following is an example thereof.

For example, assume there are four online answerers A, B, C, and D, sequence numbers of the four online answerers A, B, C, and D in a descending order of the average speeds are 1, 2, 3, and 4 respectively, sequence numbers of the four online answerers A, B, C, and D in a descending order of the correctness rates are 1, 4, 2, and 3 respectively, then the sum of the sequence numbers of each online answerers is calculated, that is 1+1=2 for answerer A, 2+4=6 for answerer B, 3+2=5 for answerer C, and 4+3=7 for answerer D, and the four online answerers may be ranked in a ascending order of the sums to form a rank of answerer A, answerer C, answerer B, and answerer D. Particularly, if the sum of an answerer is the same as that of another answerer, then the two answerers may be further ranked based on either the average speeds or correctness rates, which depends on a specific requirement of the asker.

Further, although some specific embodiments are detailed above, those skilled in the art may appreciate that there are many various implementations for determining at least one answerer according to the history answering statistics information of each online answerer.

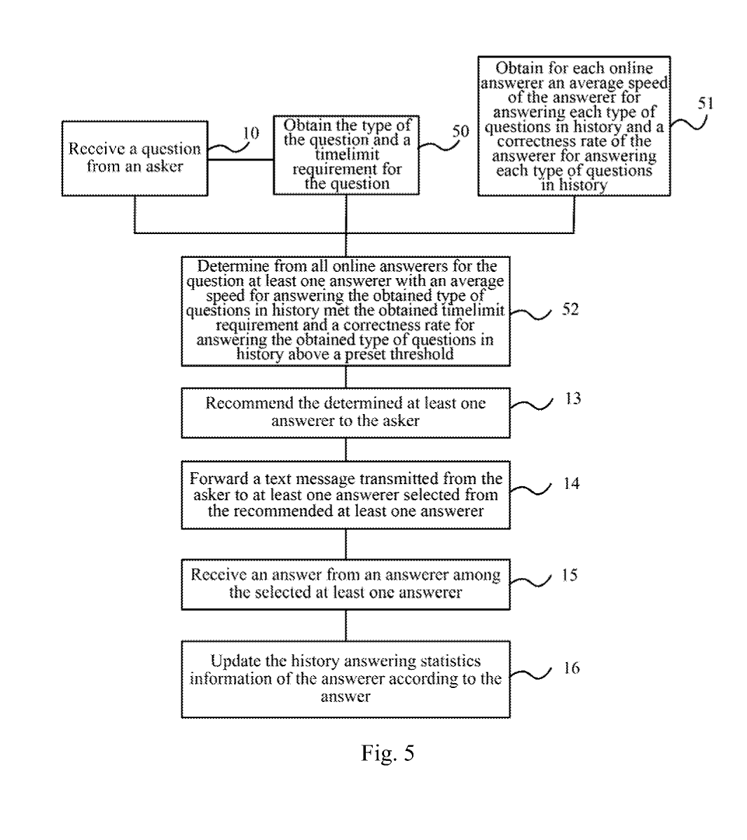

Preferably, the determining from all online answerers at least one answerer for the question according to the history answering statistics information of each online answerer as illustrated in FIG. 6 may include the following operations 120 and 121.

The operation 120 is to determine an answering willingness of each online answerer according to the history answering statistics information of the online answerer.

Particularly, when the history answering statistics information of each online answerer includes an average speed of the answerer for answering questions in history and the number of types of questions answered by the answerer in history, the answering willingness of each online answerer may be determined according to two factors (i.e., an average speed of the answerer for answering questions in history and the number of types of questions answered by the answerer in history). Preferably, the two factors are configured with an equal weight.

For example, all online answerers are ranked based on the two factors, and thus the first answerer in the rank is determined to have the highest answering willingness, the second answerer in the rank is determined to have the second highest answering willingness, and so on.

The operation 121 is to determine from all online answerers at least one answerer for the question according to the answering willingness of each online answerer.

Referring back to FIG. 1, the operation 13 is to recommend the determined at least one answerer to the asker.

The operation 14 is to forward a text message transmitted from the asker to at least one answerer selected from the recommended at least one answerer, where the text message includes the question.

Particularly, the asker may select some answerers from the recommended answerers to answer the question, and in order to guarantee quick answering, the asker may send an SMS message including the question to the selected answerers.

The operation 15 is to receive an answer from an answerer among the selected at least one answerer.

The operation 16 is to update the history answering statistics information of the answerer according to the answer.

### Second Embodiment

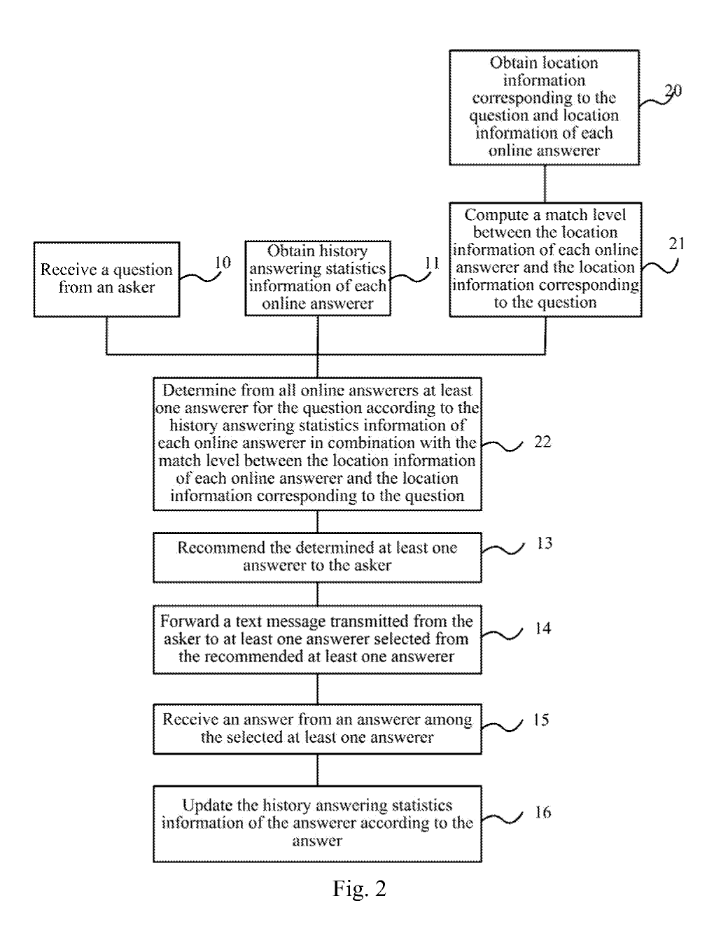

FIG. 2 illustrates a flow chart of a method for determining an answerer according to a second embodiment of the invention, which includes substantially the same operations as the first embodiment except that further operations 20 and 21 are included and an operation 22 is different from the operation 12 in the first embodiment.

The same operations as the first embodiment will not be repeated here and description thereof can be referred to the first embodiment. The following will describe the operations 20, 21 and 22.

The operation 20 is to obtain location information corresponding to the question and location information of each online answerer.

Particularly, when the question itself includes location information, the location information corresponding to the question is the location information included by the question itself, and when the question itself does not include location information, the location information corresponding to the question is location information of the asker. For example, an asker at a location M may raise a question related to a location N, thus the question itself includes location information, i.e., location N, and then the location information corresponding to the question is the location N; or, if a question raised by the asker at the location M does not include location information, then the location information corresponding to the question is the location information of the asker, i.e., location M.

Particularly, the location information of each online answerer may be the current location of the online answerer and/or a location in which the online answerer was within a reasonable time frame. For example, an answerer currently in Location M may have stayed in Location N in the past few hours, and then the location information of the answerer may be Location M and/or Location N.

The operation 21 is to compute a match level between the location information of each online answerer and the location information corresponding to the question.

The operation 22 is to determine from all online answerers at least one answerer for the question according to the history answering statistics information of each online answerer in combination with the match level between the location information of each online answerer and the location information corresponding to the question.

With the solution in the second embodiment, a location-sensitive question may be morely likely to get a correct answer.

### Third Embodiment

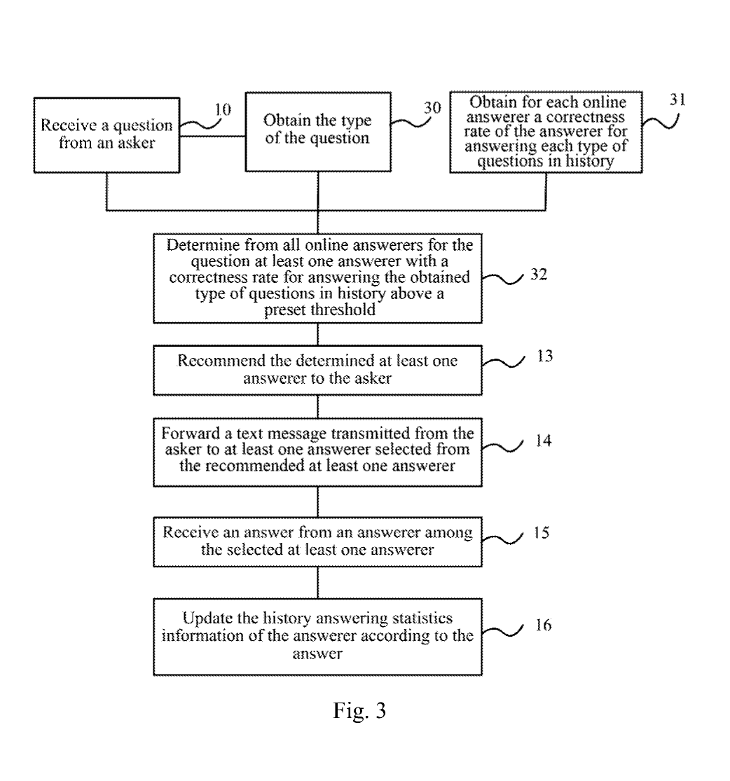

FIG. 3 illustrates a flow chart of a method for determining an answerer according to a third embodiment of the invention, which includes substantially the same operations as the first embodiment except that further operations 30 is included and operations 31 and 32 are different from the operations 11 and 12 in the first embodiment.

The same operations as the first embodiment will not be repeated here and description thereof can be referred to the first embodiment. The following will describe the operations 30, 31 and 32.

The operation 30 is to obtain the type of the question.

Particularly, the type of a question may include the category and/or the topic of the question.

The operation 31 is to obtain for each online answerer a correctness rate of the answerer for answering each type of questions in history.

The operation 32 is to determine from all online answerers for the question the at least one answerer with a correctness rate for answering the obtained type of questions in history above a preset threshold.

With the solution in the third embodiment, the question may be more likely to get a correct answer.

### Fourth Embodiment

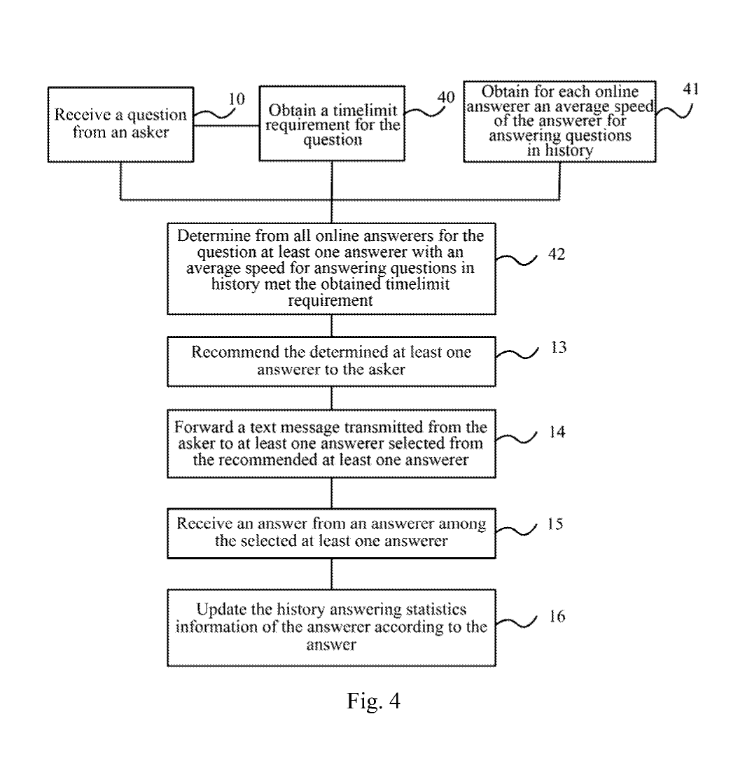

FIG. 4 illustrates a flow chart of a method for determining an answerer according to a fourth embodiment of the invention, which includes substantially the same operations as the first embodiment except that further operations 40 is included and operations 41 and 42 are different from the operations 11 and 12 in the first embodiment.

The same operations as the first embodiment will not be repeated here and description thereof can be referred to the first embodiment. The following will describe the operations 40, 41 and 42.

The operation 40 is to obtain a timelimit requirement for the question;

Particularly, the timelimit requirement is set by the asker. For example, while posting the question, the asker also put in information on the timeline that they need an answer back indicating the deadline that the question is valid until.

The operation 41 is to obtain for each online answerer an average speed of the answerer for answering questions in history.

The operation 42 is to determine from all online answerers for the question the at least one answerer with an average speed for answering questions in history met the obtained timelimit requirement.

With the solution in the fourth embodiment, a time-sensitive question may be morely likely to get a answer quickly.

### Fifth Embodiment

FIG. 5 illustrates a flow chart of a method for determining an answerer according to a fifth embodiment of the invention, which includes substantially the same operations as the first embodiment except that further operations 50 is included and operations 51 and 52 are different from the operations 11 and 12 in the first embodiment.

The same operations as the first embodiment will not be repeated here and description thereof can be referred to the first embodiment. The following will describe the operations 50, 51 and 52.

The operation 50 is to obtain the type of the question and a timelimit requirement for the question;

The operation 51 is to obtain for each online answerer an average speed of the answerer for answering each type of questions in history and a correctness rate of the answerer for answering each type of questions in history.

The operation 52 is to determine from all online answerers for the question the at least one answerer with an average speed for answering the obtained type of questions in history met the obtained timelimit requirement and a correctness rate for answering the obtained type of questions in history above a preset threshold.

With the solution in the fifth embodiment, a time-sensitive question may be morely likely to get a correct answer quickly.

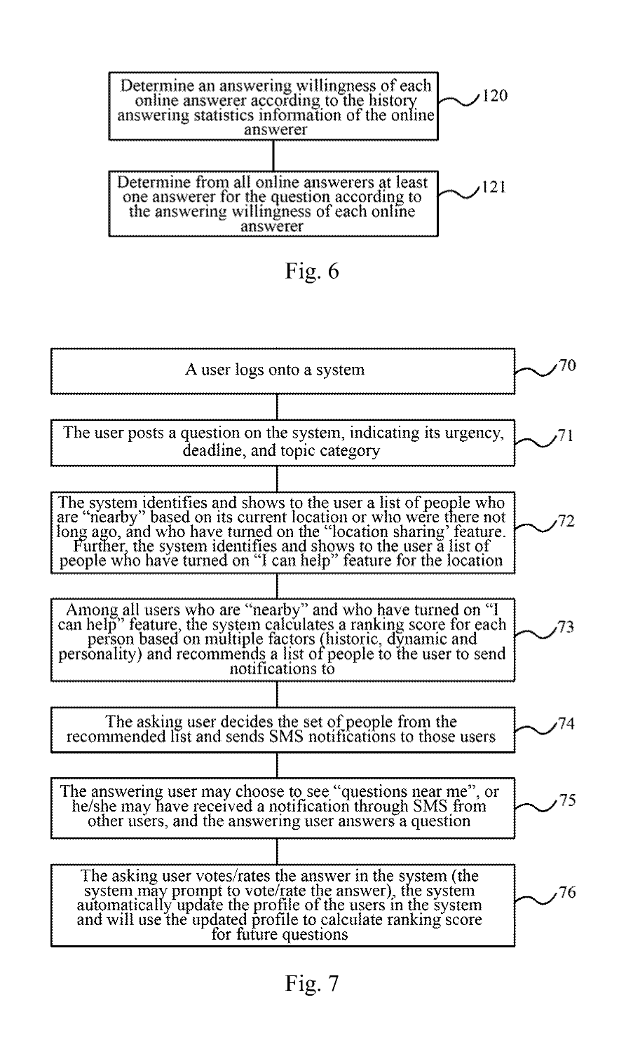

FIG. 7 illustrates a flow chart of a particular implementation of a method for determining an answerer according to an embodiment of the invention, which includes the following operations 70 to 76.

Operation 70: A user logs onto a system (e.g., a question answering platform).

A telecommunication company or an entity that can get to access user location information can utilize the solution according to the embodiments of the invention to build such a question answering platform.

“I need help” and “I can help” functionalities are provided in the system according to the embodiments of the invention. “I need help” is for question askers, and “I can help” is for question answerers.

Each user needs to register to the system in order to use it. Anytime when one logs onto the system, one can opt to turn on or off his “location-sharing” feature. Only when this feature is turned on can other people see him in the system. When a user is offering “I can help”, he can also turn on “I can help” feature, so that other people know he is available to answer questions at that moment.

Operation 71: The user posts a question on the system, indicating its urgency, deadline, and topic category.

The system provides “I need help” and allows users to post questions.

When posting questions, in addition to the question itself, users can specify which topic categories it belongs to, for example, “weather”, “traffic”, or type in any topics in free-text form. Users are also required to put in information on the timeline that they need the answer back indicating the deadline that the question is valid until. Furthermore, questions will be automatically listed/categorized based on the locations that the users are currently at. But the system allows users to change the locations where the question is valid for. Inside each location, questions are listed with their time urgency (valid-through timeline) and topic category.

Operation 72: The system identifies and shows to the user a list of people who are “nearby” based on its current location or who were there not long ago, and who have turned on the “location sharing’ feature. Further, the system identifies and shows to the user a list of people who have turned on “I can help” feature for the location.

The system provide “user nearby” feature to see other users who are currently nearby and who have turned on their location-sharing features. “User offering help” is the list of those people who have turned on “I can help” for the location.

When displaying each person's information, the system will show his current location, but also show questions answering history statistics, including type of questions answered, the topics categories of the questions, and the average speed for answering questions (within how long he answers the question after the question is posted or he logged on, whichever is later), each of these statistic information is separately shown for questions answered correctly or incorrectly. The system automatically profiles users and analyzes these features.

Operation 73: Among all users who are “nearby” and who have turned on “I can help” feature, the system calculates a ranking score for each person based on multiple factors (historic, dynamic and personality) and recommends a list of people to the user to send notifications to.

The system will notify some users marked with “I can help” with the question. The user answering history statistics enables the system to choose the right set of answerers to notify the question. In fact the system will automatically rank the potential answerers and send top answerers about the question to so as to maximize the chance to get the question answered correctly and in a timely manner. The notification can be sent via a text messaging to the potential answerers. It is up to the asker to decide how many answerers they want to choose to notify and send text messages about his question.

The rank of an online user as potential answerer to a question is based on multiple factors including the online user's answering history statistics. One factor is his answer correctness rate in general as well as in the specific topic category that the question is about. The more questions the user has answered correctly in the past in the category of the current asking question, the better this user is suitable and capable of answering the current question.

Another factor is how well the dynamic context of the question matches with the user. For example, the location matches (the user is currently at that location or was in that location within reasonable time frame).

Yet another very important factor we consider is how willing a user is to answer other people's question in general. This is especially important for time-sensitive mobile questions that demands almost real-time answer. This factor is independent of the current question. Our system derives this factor for an online user based on other information in the user's answering history. In a preferred embodiment, our system derives an online user's willingness to answer question based on how fast and how many diverse topics of questions he has answered in the past.

Combining the above factors, a ranking score of a person may be calculated as:

S=w1*(dynamic context matches)+w2*(how much he is willing to answer questions in general)+w3*(topic matches between current question and his correct answer history).

The choices of weights should w1>w2>w3. However the weights can be adjusted dynamically for each question. For example, the more urgent and the more location-sensitive the question is, the more weight the system puts on w1 and w2.

Particularly, in an embodiment, a ranking score for a user is calculated based on the match between the type of the current question asked and the user's correctly answered question history.

Particularly, in an embodiment, a ranking score for a user is calculated based on the match between the dynamic contexts of the current question asked and the user's current context. Particularly, the dynamic context of the question includes the time and location of the asker of the question.

Particularly, in an embodiment, a ranking score for a user is calculated based on his willingness to answer questions in general regardless of the current question.

Operation 74: The asking user decides the set of people from the recommended list and sends SMS notifications to those users.

The set of people is notified about the asked question.

Operation 75: The answering user may choose to see “questions near me”, or he/she may have received a notification through SMS from other users, and the answering user answers a question.

Upon an answer is received from an answerer, the answerer's history answering statistics information is updated.

The system may provide “questions asked near me” and allows users to answer questions asked near their current location. Users are also allowed to answer questions in a location that they choose to. However, when a user in location A is answering a question posted associated with location B, the system will automatically indicate to the asker that the answering user is not currently at location B.

Operation 76: The asking user votes/rates the answer in the system (the system may prompt to vote/rate the answer), the system automatically update the profile of the users in the system and will use the updated profile to calculate ranking score for future questions.

After one or more people answer the question, the asker can vote/rate the answers. These votes/ratings are dynamically incorporated and used to update the online user's answering history. That is, upon an answer is received from an answerer, the answerer's history answering statistics information is updated based on asker's feedback on the answer. The update can be done at the system's predetermined update interval. It can be even real time.

In the particular implementation detailed above, when a user turns on “I can help” feature, he/she may get notified with other people's posted questions, this facilitates the answerers to answer the right questions easily without needing to search.

Embodiments of the invention provide an automatic approach to analyze and facilitate a real-time question to have maximum chance to be answered and answered correctly and in a timely manner. The proposed approaches automatically profile user features on his question answering history statistics and intelligently figure out those people who are the “right” people to answer the questions at that moment (dynamic context). These approaches allow the questions be sent or got notified with the people who are mostly likely to give the right answer in the timely manner.

Furthermore, the proposed approach is user privacy friendly, because the system only recommends people who have turned on “location sharing” and “I can help” features.

Compared to existing approaches, the solution is more intelligent. It gives users more guarantees that their questions will be answered, and will be answered correctly and in a timely manner.

The embodiments of the invention propose smart ways to help build a smart social platform that allows mobile users to post and answer real-time questions anywhere anytime, to facilitate users to get their questions answered more likely and in a more timely and reliable way.

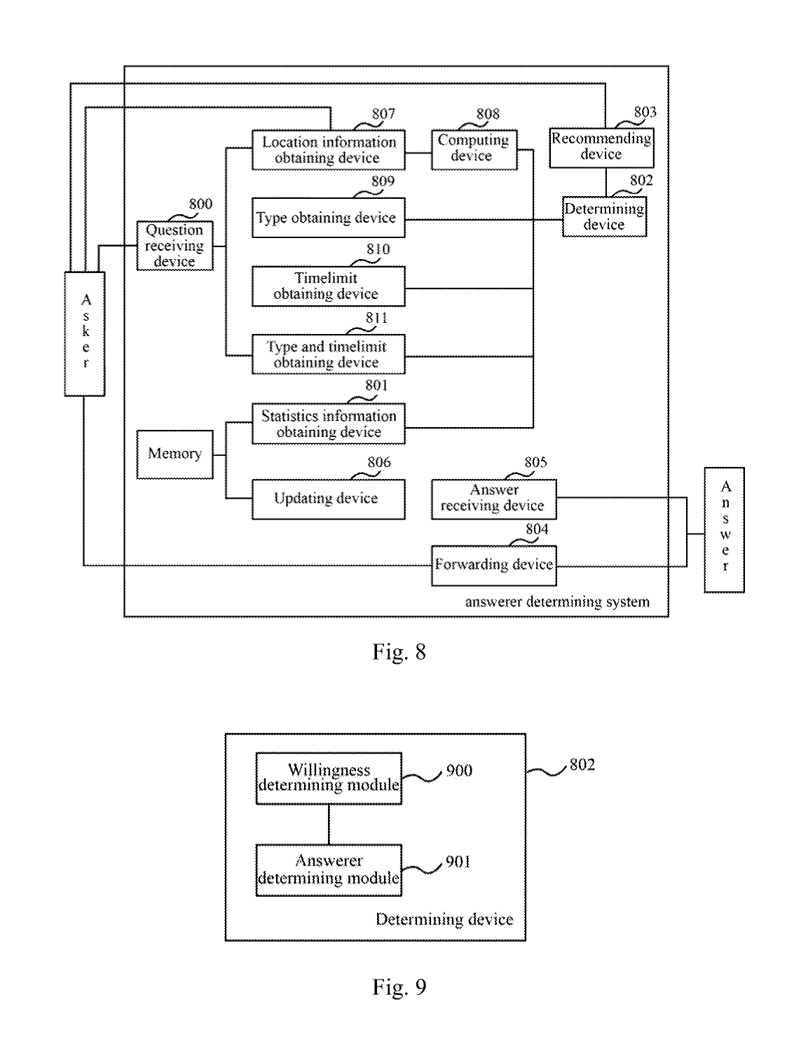

FIG. 8 is a schematic structural diagram of a system for determining an answerer according to an embodiment of the invention, which includes a question receiving device 800, a statistics information obtaining device 801, a determining device 802, a recommending device 803, a forwarding device 804, an answer receiving device 805, an updating device 806, a location information obtaining device 807, a computing device 808, a type obtaining device 809, a timelimit obtaining device 810, and a type and timelimit obtaining device 811.

The question receiving device 800 is configured to receive a question from an asker.

The statistics information obtaining device 801 is configured to obtain history answering statistics information of each online answerer, where an online answerer is a user with a label which represents that the user is available to answer a question.

The determining device 802 is configured to determine from all online answerers at least one answerer for the question according to the history answering statistics information of each online answerer.

Particularly the history answering statistics information of each online answerer includes at least one of: an average speed of the answerer for answering questions in history; the number of types of questions answered by the answerer in history; an average speed of the answerer for answering each type of questions in history; the number of questions answered by the answerer in history; the number of each type of questions answered by the answerer in history; a correctness rate of the answerer for answering questions in history; a correctness rate of the answerer for answering each type of questions in history; the types of questions answered correctly by the answerer in history, etc.

The recommending device 803 is configured to recommend the at least one answerer determined by the determining device to the asker.

The forwarding device 804 is configured to forward a text message transmitted from the asker to at least one answerer selected from the at least one answerer recommended by the recommending device, where the text message includes the question.

The answer receiving device 805 is configured to receive an answer from an answerer among the selected at least one answerer.

The updating device 806 is configured to update the history answering statistics information of the answerer according to the answer.

The location information obtaining device 807 is configured to obtain location information corresponding to the question and location information of each online answerer, where when the question itself includes location information, the location information corresponding to the question is the location information included by the question itself, and when the question itself does not include location information, the location information corresponding to the question is location information of the asker;

The computing device 808 is configured to compute a match level between the location information of each online answerer and the location information corresponding to the question; and the determining device 802 is further configured to determine the at least one answerer according to the history answering statistics information of each online answerer in combination with the match level between the location information of each online answerer and the location information corresponding to the question.

The type obtaining device 809 is configured to obtain the type of the question; and when the history answering statistics information of each online answerer includes a correctness rate of the answerer for answering each type of questions in history, the determining device 802 is further configured to determine from all online answerers for the question the at least one answerer with a correctness rate for answering the obtained type of questions in history above a preset threshold.

The timelimit obtaining device 810 is configured to obtain a timelimit requirement for the question; and when the history answering statistics information of each online answerer includes an average speed of the answerer for answering questions in history, the determining device 802 is further configured to determine from all online answerers for the question the at least one answerer with an average speed for answering questions in history met the obtained timelimit requirement.

The type and timelimit obtaining device 811 is configured to obtain the type of the question and a timelimit requirement for the question; and when the history answering statistics information of each online answerer includes an average speed of the answerer for answering each type of questions in history and a correctness rate of the answerer for answering each type of questions in history, the determining device 802 is further configured to determine from all online answerers for the question the at least one answerer with an average speed for answering the obtained type of questions in history met the obtained timelimit requirement and a correctness rate for answering the obtained type of questions in history above a preset threshold.

Particularly, a schematic structural diagram of the determining device 802 is as illustrated in FIG. 9.

As illustrated in FIG. 9, the determining device 802 includes a willingness determining module 901 and an answerer determining module 902.

The willingness determining module 901 is configured to determine an answering willingness of each online answerer according to the history answering statistics information of the online answerer.

Particularly, when the history answering statistics information of each online answerer includes an average speed of the answerer for answering questions in history and the number of types of questions answered by the answerer in history, the willingness determining module 901 is further configured to determine the answering willingness of each online answerer according to two factors of an average speed of the answerer for answering questions in history and the number of types of questions answered by the answerer in history, wherein the two factors are configured with an equal weight.

The answerer determining module 902 is configured to determine from all online answerers at least one answerer for the question according to the answering willingness of each online answerer.

With the solutions in the embodiments of the invention, at least one answerer which is more likely to answer a question from an asker correctly and in a timely manner can be determined, thus guaranteeing questions of askers being answered and being answered correctly and in a timely manner.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

What is claimed is:

1. A method for determining an answerer, comprising:
receiving a question from an asker;
obtaining history answering statistics information of each online answerer, wherein an online answerer is a user with a label which represents that the user is available to answer a question; and
determining from all online answerers at least one answerer for the question according to the history answering statistics information of each online answerer.

2. The method of claim 1, wherein the history answering statistics information of each online answerer comprises at least one of:
an average speed of the answerer for answering questions in history;
the number of types of questions answered by the answerer in history;
an average speed of the answerer for answering each type of questions in history;
the number of questions answered by the answerer in history;
the number of each type of questions answered by the answerer in history;
a correctness rate of the answerer for answering questions in history;
a correctness rate of the answerer for answering each type of questions in history; and
the types of questions answered correctly by the answerer in history.

3. The method of claim 2, wherein the determining from all online answerers at least one answerer for the question according to the history answering statistics information of each online answerer comprises:
determining an answering willingness of each online answerer according to the history answering statistics information of the online answerer; and
determining from all online answerers at least one answerer for the question according to the answering willingness of each online answerer.

4. The method of claim 3, wherein when the history answering statistics information of each online answerer comprises an average speed of the answerer for answering questions in history and the number of types of questions answered by the answerer in history, the determining an answering willingness for each online answerer according to the history answering statistics information of the online answerer comprises:
determining the answering willingness of each online answerer according to two factors of an average speed of the answerer for answering questions in history and the number of types of questions answered by the answerer in history; wherein the two factors are configured with an equal weight.

5. The method of claim 2, further comprising:
recommending the determined at least one answerer to the asker; and
forwarding a text message transmitted from the asker to at least one answerer selected from the recommended at least one answerer, wherein the text message comprises the question.

6. The method of claim 5, further comprising:
receiving an answer from an answerer among the selected at least one answerer; and
updating the history answering statistics information of the answerer according to the answer.

7. The method of claim 2, further comprising:
obtaining location information corresponding to the question and location information of each online answerer, wherein when the question itself comprises location information, the location information corresponding to the question is the location information comprised by the question itself, and when the question itself does not comprise location information, the location information corresponding to the question is location information of the asker; and
computing a match level between the location information of each online answerer and the location information corresponding to the question;
and wherein the determining from all online answerers at least one answerer for the question according to the history answering statistics information of each online answerer comprises:
determining the at least one answerer according to the history answering statistics information of each online answerer in combination with the match level between the location information of each online answerer and the location information corresponding to the question.

8. The method of claim 2, further comprising:
obtaining the type of the question;
and wherein when the history answering statistics information of each online answerer comprises a correctness rate of the answerer for answering each type of questions in history, the determining from all online answerers at least one answerer for the question according to the history answering statistics information of each online answerer comprises:
determining from all online answerers for the question the at least one answerer with a correctness rate for answering the obtained type of questions in history above a preset threshold.

9. The method of claim 2, further comprising:
obtaining a timelimit requirement for the question;
and wherein when the history answering statistics information of each online answerer comprises an average speed of the answerer for answering questions in history, the determining from all online answerers at least one answerer for the question according to the history answering statistics information of each online answerer comprises:
determining from all online answerers for the question the at least one answerer with an average speed for answering questions in history met the obtained timelimit requirement.

10. The method of claim 2, further comprising:
obtaining the type of the question and a timelimit requirement for the question;
and wherein when the history answering statistics information of each online answerer comprises an average speed of the answerer for answering each type of questions in history and a correctness rate of the answerer for answering each type of questions in history, the determining from all online answerers at least one answerer for the question according to the history answering statistics information of each online answerer comprises:
determining from all online answerers for the question the at least one answerer with an average speed for answering the obtained type of questions in history met the obtained timelimit requirement and a correctness rate for answering the obtained type of questions in history above a preset threshold.

11. A system for determining an answerer, comprising:
a question receiving device configured to receive a question from an asker;
a statistics information obtaining device configured to obtain history answering statistics information of each online answerer, wherein an online answerer is a user with a label which represents that the user is available to answer a question; and
a determining device configured to determine from all online answerers at least one answerer for the question according to the history answering statistics information of each online answerer.

12. The system of claim 11, wherein the history answering statistics information of each online answerer comprises at least one of:
an average speed of the answerer for answering questions in history;
the number of types of questions answered by the answerer in history;
an average speed of the answerer for answering each type of questions in history;
the number of questions answered by the answerer in history;
the number of each type of questions answered by the answerer in history;
a correctness rate of the answerer for answering questions in history;
a correctness rate of the answerer for answering each type of questions in history; and
the types of questions answered correctly by the answerer in history.

13. The system of claim 12, wherein the determining device comprises:
a willingness determining module configured to determine an answering willingness of each online answerer according to the history answering statistics information of the online answerer; and
an answerer determining module configured to determine from all online answerers at least one answerer for the question according to the answering willingness of each online answerer.

14. The system of claim 13, wherein when the history answering statistics information of each online answerer comprises an average speed of the answerer for answering questions in history and the number of types of questions answered by the answerer in history, the willingness determining module is further configured:
to determine the answering willingness of each online answerer according to two factors of an average speed of the answerer for answering questions in history and the number of types of questions answered by the answerer in history, wherein the two factors are configured with an equal weight.

15. The system of claim 12, further comprising:
a recommending device configured to recommend the at least one answerer determined by the determining device to the asker; and
a forwarding device configured to forward a text message transmitted from the asker to at least one answerer selected from the at least one answerer recommended by the recommending device, wherein the text message comprises the question.

16. The system of claim 15, further comprising:
an answer receiving device configured to receive an answer from an answerer among the selected at least one answerer; and
an updating device configured to update the history answering statistics information of the answerer according to the answer.

17. The system of claim 12, further comprising:
a location information obtaining device configured to obtain location information corresponding to the question and location information of each online answerer, wherein when the question itself comprises location information, the location information corresponding to the question is the location information comprised by the question itself, and when the question itself does not comprise location information, the location information corresponding to the question is location information of the asker; and
a computing device configured to compute a match level between the location information of each online answerer and the location information corresponding to the question;
and wherein the determining device is further configured to determine the at least one answerer according to the history answering statistics information of each online answerer in combination with the match level between the location information of each online answerer and the location information corresponding to the question.

18. The system of claim 12, further comprising:
a type obtaining device configured to obtain the type of the question;
and wherein when the history answering statistics information of each online answerer comprises a correctness rate of the answerer for answering each type of questions in history, the determining device is further configured to determine from all online answerers for the question the at least one answerer with a correctness rate for answering the obtained type of questions in history above a preset threshold.

19. The system of claim 12, further comprising:
a timelimit obtaining device configured to obtain a timelimit requirement for the question;
and wherein when the history answering statistics information of each online answerer comprises an average speed of the answerer for answering questions in history, the determining device is further configured to determine from all online answerers for the question the at least one answerer with an average speed for answering questions in history met the obtained timelimit requirement.

20. The system of claim 12, further comprising:
a type and timelimit obtaining device configured to obtain the type of the question and a timelimit requirement for the question;
and wherein when the history answering statistics information of each online answerer comprises an average speed of the answerer for answering each type of questions in history and a correctness rate of the answerer for answering each type of questions in history, the determining device is further configured to determine from all online answerers for the question the at least one answerer with an average speed for answering the obtained type of questions in history met the obtained timelimit requirement and a correctness rate for answering the obtained type of questions in history above a preset threshold.
